(19) United States
(12) Patent Application Publication
(10) Pub. No.: US 2011/0173081 A1
(43) Pub. Date: Jul. 14, 2011

(54) SYSTEMS AND METHODS USING POINT-OF-SALE CUSTOMER IDENTIFICATION

(75) Inventor: Kevin M. Crucs, Copley, OH (US)

(73) Assignee: CRUCS HOLDINGS, LLC, Copley, OH (US)

(21) Appl. No.: 12/685,387

(22) Filed: Jan. 11, 2010

(51) Int. Cl. G06Q 30/00; G06F 7/04; G06Q 10/00; G06Q 20/00

(52) U.S. Cl. 705/16; 340/5.81; 340/5.83; 705/17; 705/21; 705/304; 345/173; 705/7.29

(57) ABSTRACT

System and method for automatically providing tailored customer services at a point-of-sale location. An identity of a customer approaching the point-of-sale location is automatically determined using an auto-identifying technology. Stored customer activity data corresponding to the identified customer is automatically accessed using a computer-based system operatively interfacing to the auto-identifying technology. At least one tailored customer service is automatically generated for the customer by processing at least a portion of the accessed customer activity data using the computer-based system.

### TECHNICAL FIELD

Certain embodiments of the present invention relate to point-of-sale applications. More particularly, certain embodiments relate to systems and methods providing tailored customer services at a point-of-sale location upon automatic identification of a customer approaching the point-of-sale location.

### BACKGROUND

Consumers are often creatures of habit and tend to buy the same items or types of items over and over again from a particular point-of-sale establishment in a same manner. For example, a customer that frequents a particular fast food restaurant may tend to order the same item or items each time, or may tend to order only a limited number of different types of items. Similarly, a customer that frequents a particular clothing store may tend to purchase only certain types of items from that clothing store, even though the clothing store may offer a much larger variety of items. A customer that frequents a sit down restaurant may tend to sit in the same place in the restaurant each time, and may tend to like to use a particular waitress each time, for example. Such consumer habits, preferences, likes, and dislikes may or may not be noticed or captured in some way by the point-of-sale establishment, and may or may not be used to the advantage of the point-of-sale establishment to better serve its customers.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises a method for automatically providing tailored customer services at a point-of-sale location. The method includes automatically determining an identity of a customer approaching the point-of-sale location using an auto-identifying technology. The method further includes automatically accessing stored customer activity data corresponding to the customer in response to the determined identity using a computer-based system operatively interfacing to the auto-identifying technology. The method also includes generating at least one tailored customer service for the customer by processing at least a portion of the accessed customer activity data using the computer-based system. The auto-identifying technology may include an identification card and a card reading technology, or a face-recognition technology, or some other biometric identification technology, or a radio frequency identification (RFID) technology. The computer-based system may include a database storing the customer activity data and at least one microprocessor for processing at least a portion of the customer activity data. The customer activity data may include at least one of prior actual purchase data of the customer, prior actual order data of the customer, preferences of the customer, demographic data of the customer, personal information of the customer, and notes entered relating to the customer. Generating at least one tailored customer service may include at least one of automatically placing an order for the customer and/or automatically making payment for the placed order, automatically displaying likely orders in a computer-selectable format such that the customer and/or a sales person can select at least one of the displayed likely orders using the computer-based system, automatically placing the customer in a queue, and automatically determining where to seat the customer.

Another embodiment of the present invention comprises a system for automatically providing tailored customer services at a point-of-sale location. The system includes at least one sensor capable of sensing at least one characteristic feature of a customer. The system also includes an auto-identifier computer operatively connected to the sensor and capable of automatically establishing an identity of a customer approaching the point-of-sale location in response to the characteristic feature of the customer. The system further includes a customer activity database storing customer activity information. The system also includes a customer service computer operatively connected to the auto-identifier computer and the customer activity database and capable of automatically accessing the stored customer activity data from the database corresponding to the customer in response to the determined identity, and further capable of automatically generating at least one tailored customer service for the customer by processing at least a portion of the accessed customer activity data. The system further includes a point-of-sale display operatively connected to the customer service computer and capable of displaying at least a portion of the tailored customer service. The customer activity data may include at least one of prior actual purchase data of the customer, prior actual order data of the customer, preferences of the customer, demographic data of the customer, personal information of the customer, and notes entered relating to the customer. The tailored customer service may include at least one of automatically placing an order for the customer and/or automatically making payment for the placed order, automatically displaying likely orders in a computer-selectable format such that the customer and/or a sales person can select at least one of the displayed likely orders, automatically placing the customer in a queue, and automatically determining where to seat the customer.

A further embodiment of the present invention comprises a system for automatically providing tailored customer services at a point-of-sale location. The system includes means for automatically determining an identity of a customer approaching the point-of-sale location. The system further includes means for automatically accessing stored customer activity data corresponding to the customer in response to the determined identity. The system also includes means for automatically generating at least one tailored customer service for the customer by using at least a portion of the accessed customer activity data. The customer activity data may include at least one of prior actual purchase data of the customer, prior actual order data of the customer, preferences of the customer, demographic data of the customer, personal information of the customer, and notes entered relating to the customer. The means for automatically generating at least one tailored customer service may include means for automatically placing and order for the customer and/or means for making payment for the order. The means for automatically generating at least one tailored customer service may include means for automatically displaying likely orders in a computer-selectable format. The means for automatically generating at least one tailored customer service may include means for the customer and/or a salesperson to select at least one of the displayed likely orders. The means for automatically generating at least one tailored customer service may include means for automatically placing the customer into a queue and/or means for automatically determining where to seat the customer.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a schematic block diagram of a first example embodiment of a system for automatically providing tailored customer services at a point-of-sale location;

FIG. 2 illustrates a schematic block diagram of a second example embodiment of a system for automatically providing tailored customer services at a point-of-sale location;

FIG. 3 is a flowchart of an example embodiment of a method for automatically providing tailored customer services at a point-of-sale location;

FIG. 4 illustrates a first example embodiment of customer activity data stored in the system of FIG. 1;

FIG. 5 illustrates a first example embodiment of a tailored customer service derived from the customer activity data of FIG. 4 using the system of FIG. 1;

FIG. 6 illustrates a second example embodiment of customer activity data stored in the system of FIG. 1;

FIG. 7 illustrates a second example embodiment of a tailored customer service derived from the customer activity data of FIG. 6 using the system of FIG. 1;

FIG. 8 illustrates a third example embodiment of customer activity data stored in the system of FIG. 1; and

FIG. 9 illustrates a third example embodiment of a tailored customer service derived from the customer activity data of FIG. 8 using the system of FIG. 1.

### DETAILED DESCRIPTION

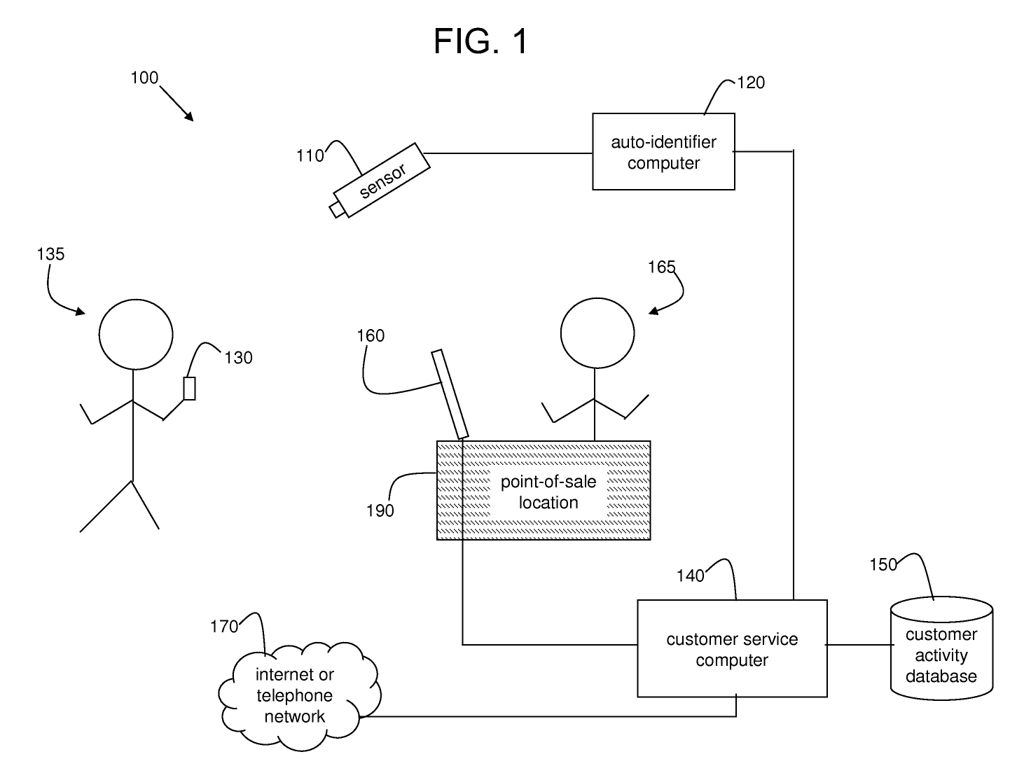

FIG. 1 illustrates a schematic block diagram of a first example embodiment of a system 100 for automatically providing tailored customer services at a point-of-sale location 190. The point-of-sale location 190 may be a sales counter manned by a salesperson 165 in a clothing store or in a restaurant, for example. The system 100 includes auto-identifying technology comprising a sensor 110 operatively connected to an auto-identifier computer 120 and, in accordance with at least one embodiment, an identification card 130. The auto-identifying technology is used to automatically identify a customer 135 when the customer 135 approaches the point-of-sale location 190. In accordance with various embodiments of the present invention, the auto-identifying technology may include, for example, at least one of card-reading technology, RFID technology, face-recognition technology, or some other biometric identification technology. Other auto-identifying technologies may be possible as well. In accordance with an embodiment of the present invention, the auto-identifier computer 120 includes a microprocessor, memory, and digital storage, and is capable of running an auto-identifying software application (e.g., a face-recognition algorithm).

For example, the sensor 110 (e.g., a card reader) may read the card 130 (e.g., a magnetic strip card or a card having an RFID tag with identifying information stored thereon) and send the read information to the auto-identifier computer 120 where the read information is matched to a particular customer 135. Alternatively, the sensor 110 (e.g., a camera) may capture an image of the face of the customer 135 and send the image information to the auto-identifier computer 120 where the image information is processed to identify the customer 135 by matching features of the image information to stored features in the auto-identifier computer 120 corresponding to the customer 135. Other means and methods of identifying the customer 135 are possible as well using other auto-identifying technologies. In accordance with an embodiment of the present invention, the auto-identifying technology of the system 100 is capable of identifying many different customers.

The system 100 also includes a customer service computer 140 operatively connected to the auto-identifier computer 120. The system 100 further includes a customer activity database 150 operatively connected to the customer service computer 140. The auto-identifier computer 120 sends the identifying information (e.g., an identifying numeric code or an identifying name) to the customer service computer 140. The customer service computer 140 uses the identifying information to access stored customer activity data corresponding to the identified customer 135 from the customer activity database 150. In accordance with an embodiment of the present invention, the customer activity database 150 stores customer activity data for many different customers. In accordance with an embodiment of the present invention, the customer service computer 140 includes a microprocessor, memory, and digital storage, and is capable of running a customer service software application for generating a tailored customer service. The customer service software application may include an algorithm (e.g., a likelihood algorithm and/or a ranking algorithm) adapted to operate on at least a portion of the customer activity data to, for example, determine the likelihood and/or the rank of an item being ordered.

The customer activity data may include, for example, prior actual purchase data of the identified customer 135, prior actual order data of the identified customer 135, preferences of the identified customer 135, demographic data of the identified customer 135, personal information of the identified customer 135, and notes entered relating to the identified customer 135. Other types of customer activity data are possible as well, in accordance with various embodiments of the present invention.

Upon accessing the customer activity data for the customer 135, the customer service computer 140 processes the customer activity data to generate at least one tailored customer service for the customer 135. A resultant tailored customer service may include, for example, any of the following: displaying at least a portion of the customer activity data to a sales person 165 on a display 160 which is also a part of the system 100; automatically placing an order for the identified customer 135 and/or automatically making payment for the order; automatically displaying likely orders for the identified customer 135 on the display 160; automatically placing the identified customer 135 into a queue; automatically determining where to seat the identified customer 135. Other tailored customer services are possible as well, in accordance with various embodiments of the present invention.

The system 100 may also be capable of interfacing with the internet or telephone network 170 (e.g., via the customer service computer 140) to allow customers at remote locations to place orders in advance. Then, when the customer arrives and approaches the point-of-sale location 190, the customer is identified and the order, which was sent in via the internet, is automatically placed. As a result, the customer does not have to wait in line to place an order upon arrival at the point-of-sale location, and the point-of-sale location does not have to actually place the order until the customer actually arrives. The system 100 may accommodate other forms of advance ordering as well including, for example, faxed orders, text message orders, and voice telephone orders, in accordance with various embodiments of the present invention.

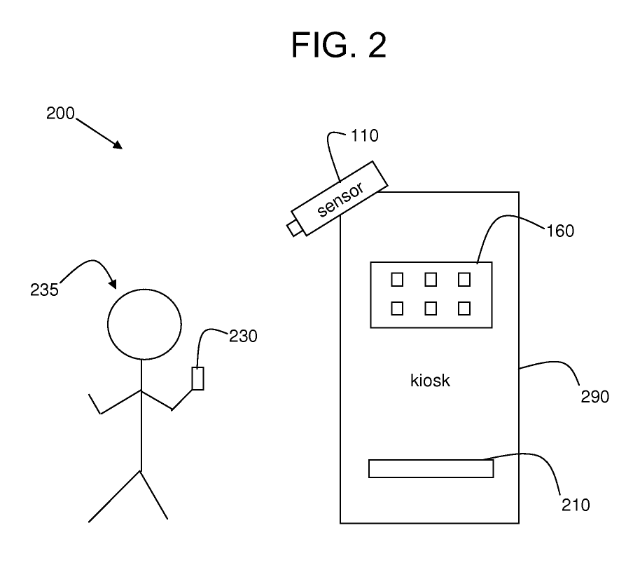

FIG. 2 illustrates a schematic block diagram of a second example embodiment of a system 200 for automatically providing tailored customer services at a point-of-sale location. In FIG. 2, the point-of-sale location is a kiosk 290. The kiosk 290 may be, for example, a vending machine capable of dispensing food items, money from an account, recorded videos, beach supplies, or any of other various types of items, from a dispensing slot 210. The kiosk 290 may include the elements of the system 100 of FIG. 1 including a sensor 110, an auto-identifier computer 120, a customer service computer 140, a customer activity database 150, and a display 160. The auto-identifier computer 120, the customer service computer 140, and the customer activity database 150 may be installed within the shell of the kiosk 290 and are not explicitly shown in FIG. 2.

A customer 235 approaching the kiosk may have an identification card 230 that can be read by the sensor 110, or some other type of auto-identifying technology may be used as previously described herein with respect to FIG. 1. The system 200 of FIG. 2 operates in a similar manner to the system 100 of FIG. 1 with respect to automatically identifying the customer 235, automatically accessing customer activity data, and automatically generating at least one tailored customer service. However, in the system 200 of FIG. 2, the customer 235 may interact directly with the system 200 and not with a salesperson 165 as in FIG. 1. For example, in the system 200 of FIG. 2, when the customer 235 approaches the kiosk 290 and is automatically identified, the customer's most ordered items or previously ordered items may be displayed on the display 160 in a computer-selectable format. The customer 235 may select one or more of the displayed items or may choose to select a different item, for example. The computer-selectable format may use touch-screen technology or voice-activated technology, for example.

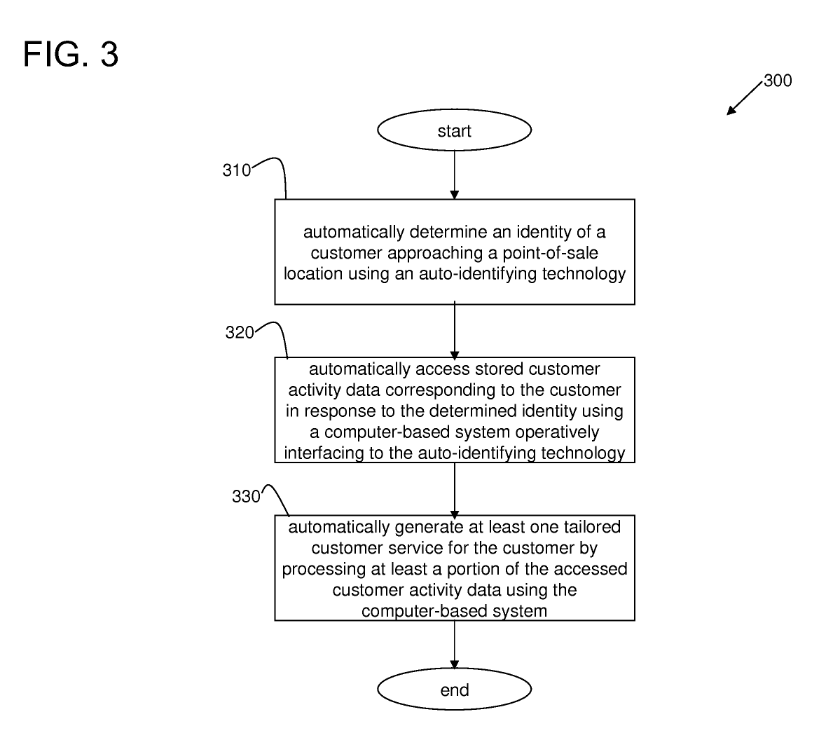

FIG. 3 is a flowchart of an example embodiment of a method 300 for automatically providing tailored customer services at a point-of-sale location. In step 310 of the method 300, automatically determine an identity of a customer approaching a point-of-sale location using an auto-identifying technology. In step 320, automatically access stored customer activity data corresponding to the customer in response to the determined identity using a computer-based system operatively interfacing to the auto-identifying technology. In step 330, automatically generate at least one tailored customer service for the identified customer by processing at least a portion of the accessed customer activity data using the computer-based system. For example, the system 100 of FIG. 1 or the system 200 of FIG. 2 may be used to execute the steps of the method 300.

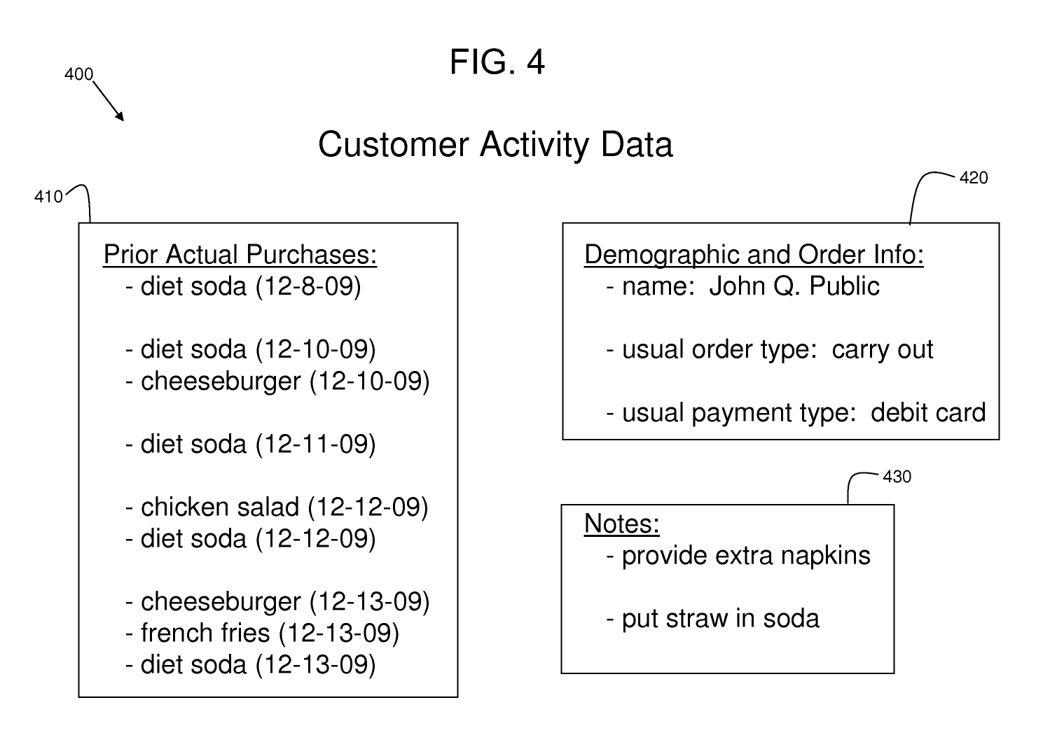

FIG. 4 illustrates a first example embodiment of customer activity data 400 stored in the system 100 of FIG. 1. The customer activity data 400 is for a regular customer of a fast food restaurant and includes data of prior actual purchases 410, demographic and order info 420, and notes 430. From the demographic and order info 420, the customer's name is John Q. Public who usually orders carry out and usually pays with a debit card. From the notes 430, the customer likes to be provided with extra napkins and likes a straw placed in his soda by the sales person. From the data of prior actual purchases 410, the customer made purchases on five days within a one week period.

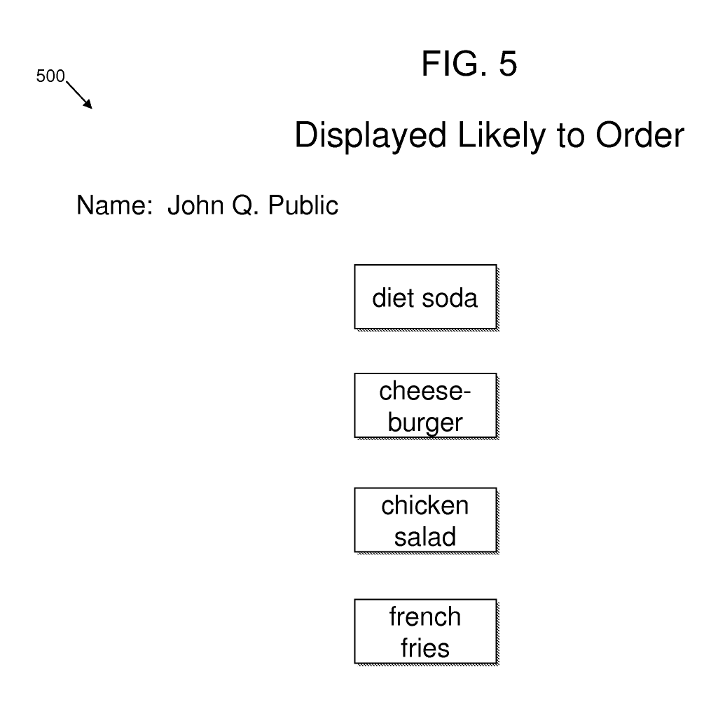

FIG. 5 illustrates a first example embodiment of a tailored customer service 500 derived from the customer activity data 400 of FIG. 4 using the system 100 of FIG. 1. The tailored customer service 500 shown in FIG. 5 is a display of items that the customer, John Q. Public, is likely to order. The information may be displayed on the display 160 of FIG. 1 in a computer-selectable format after the system 100 identifies the customer 135 as John Q. Public. As can be seen from the prior actual purchases 410 of the customer activity data 400 for John Q. Public, there are four item types that the customer has purchased (i.e., diet soda, cheeseburger, chicken salad, french fries). In fact, the customer activity data 400 shows that John Q. Public purchases a diet soda every time. The customer service computer 140 uses a customer service software application to operate on the customer activity data 400 to automatically determine and display the likely items that will be ordered by John Q. Public as the tailored customer service 500 and to display the diet soda item first since it is the item most frequently ordered by John Q. Public. In this manner, as John Q. Public approaches the point-of-sale location 190 within the fast food restaurant, the salesperson 165 is able to greet the customer 135 by name and, if John Q. Public verbally orders any of the displayed items, the sales person 165 is able to immediately select the items from the display 160 to place the order. Furthermore, the notes, order type, and payment type may be displayed next after the order is placed, thus directing the salesperson 165 to gather extra napkins, place a straw in the diet soda (if ordered), and confirm from John Q. Public that the order is “to go” and that the payment type is a debit card.

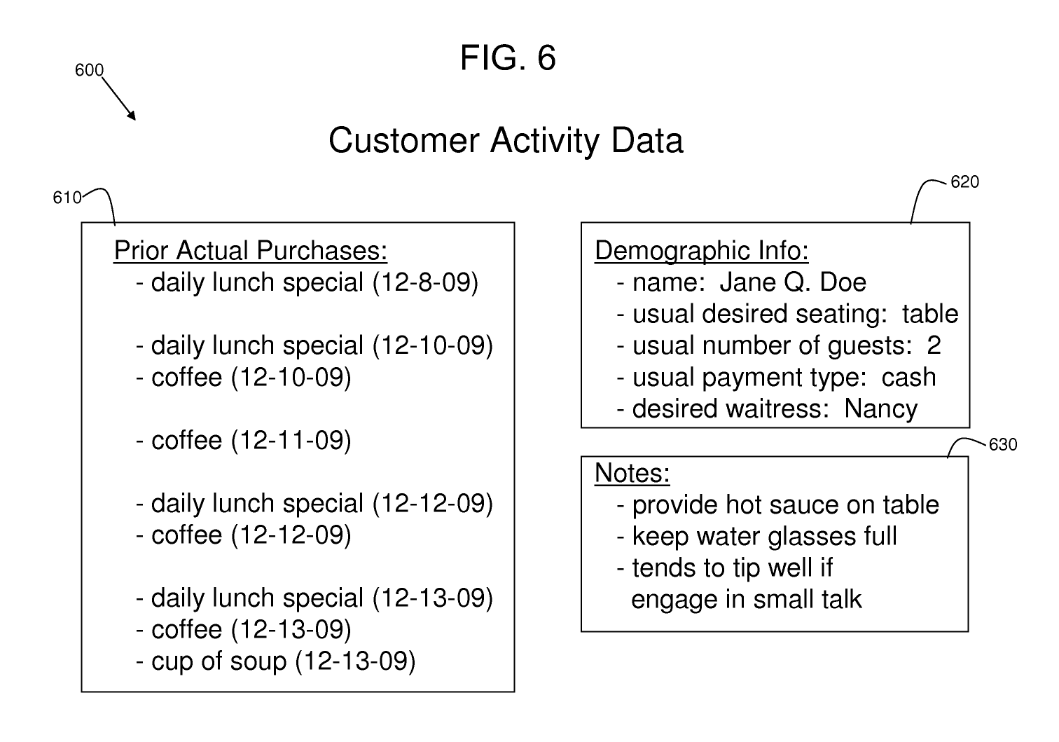

FIG. 6 illustrates a second example embodiment of customer activity data 600 stored in the system 100 of FIG. 1. The customer activity data 600 is for a regular customer of a sit down restaurant and includes data of prior actual purchases 610, demographic info 620, and notes 630. From the demographic info 620, the customer's name is Jane Q. Doe who usually brings two guests, prefers a table instead of a booth, usually pays with cash, and likes to use the waitress named Nancy. From the notes 630, the customer likes to be provided with hot sauce on the table, likes to have her glass of water kept full, and tends to tip well if the waitress makes an effort to engage in small talk. From the data of prior actual purchases 610, the customer came to the restaurant and made purchases on five days within a one week period.

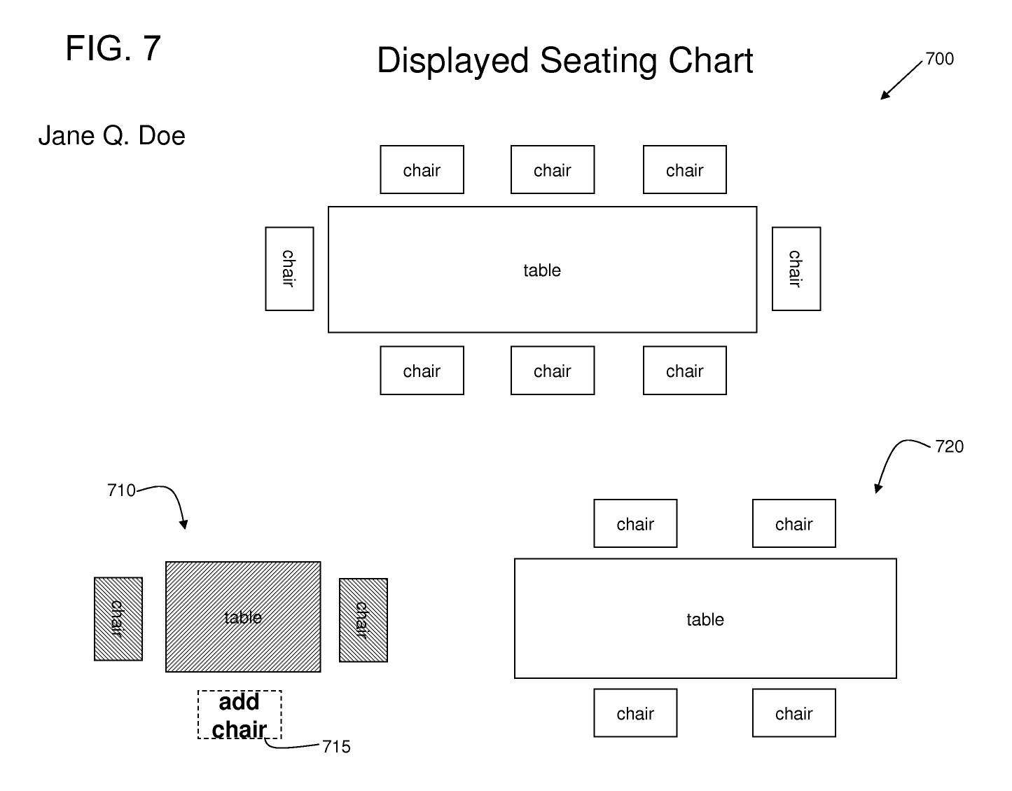

FIG. 7 illustrates a second example embodiment of a tailored customer service 700 derived from the customer activity data 600 of FIG. 6 using the system 100 of FIG. 1. The tailored customer service shown in FIG. 7 is a display of a seating chart of at least a portion of the sit down restaurant. The customer service computer 140 of the system 100 uses a customer service software application to operate on the customer activity data 600 to automatically determine and display where to seat Jane Q. Doe's party of three persons based on the customer activity data and possibly based on current available seating also, in accordance with an embodiment of the present invention. The displayed seating chart indicates (e.g., via shading) where to seat Jane Q. Doe and her two guests (seating arrangement 710), and that an extra chair 715 is to be provided to accommodate all three persons in Jane Q. Doe's party. The icon representing the added chair 715 may “flash” on and off on the display 160 to clearly draw attention to the fact that an additional chair is needed. In this manner, a worker in the restaurant can immediately be directed to fetch the additional chair.

Upon identification of Jane Q. Doe entering the restaurant by the system 100, the customer service software application of the system 100 operates on the customer activity data 600 to determine appropriate seating within the restaurant for Jane Q. Doe and her two guests. The customer service software application places the party of three at the available seating arrangement 710 in the seating chart 700 based on the likelihood that Jane Q. Doe indeed has two guests with her and the fact that seating arrangement 710 is a table and is assigned to the waitress named Nancy, who is currently on duty. In accordance with an embodiment of the present invention, the hostess 165 may select the seating arrangement 710 on the computer-selectable display 160 telling the system 100 that seating arrangement 710 is now in use. If the salesperson 165 (e.g., hostess) sees that Jane Q. Doe does not have two guests with her (e.g., instead three guests), the hostess 165 may manually re-direct the party to more appropriate seating (e.g., seating arrangement 720), or tell the system (e.g., via the computer-selectable display 160) the actual number of persons in the party, allowing the system to re-determine the appropriate seating.

In this manner, as Jane Q. Doe approaches the point-of-sale location 190 within the sit down restaurant, the hostess 165 is able to greet the customer 135 by name and immediately view the open and appropriate seating for the customer's likely party on the display 160. Furthermore, certain customer activity data (e.g., notes) may be displayed directing the hostess 165 to grab a bottle of hot sauce on her way to seating the party and to remind Nancy the waitress about keeping the water glasses full at table 710 and to engage in small talk. The hostess 165 can also confirm from the customer (Jane Q. Doe) that she will be paying in cash.

In accordance with other embodiments, a sit-down restaurant may use the system 100 to automatically place customers into a seating queue based on time of arrival, or determine if a particular customer has any special needs such as, for example, seating for the disabled or seating for children.

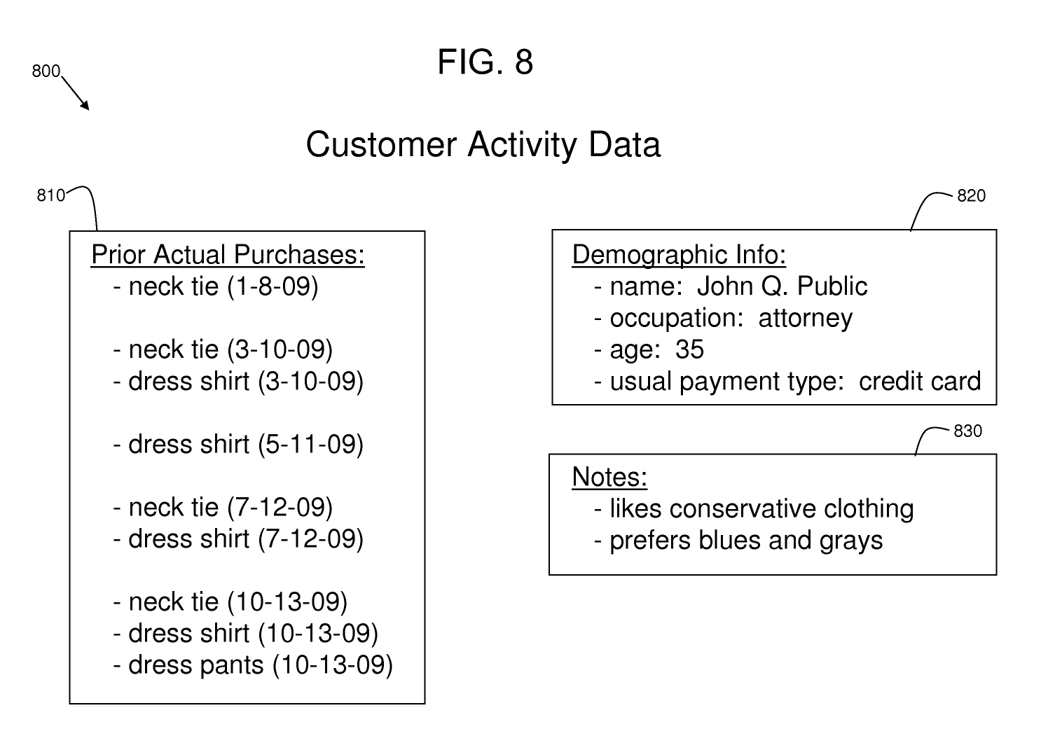

FIG. 8 illustrates a third example embodiment of customer activity data 800 stored in the system 100 of FIG. 1. The customer activity data 800 is for a regular customer of a clothing store and includes data of prior actual purchases 810, demographic info 820, and notes 830. From the demographic info 820, the customer's name is John Q. Public who is a 35 year-old attorney. From the notes 830, the customer likes conservative clothing and prefers blue and gray color clothing. From the data of prior actual purchases 810, the customer came to the clothing store on five prior dates and made purchases.

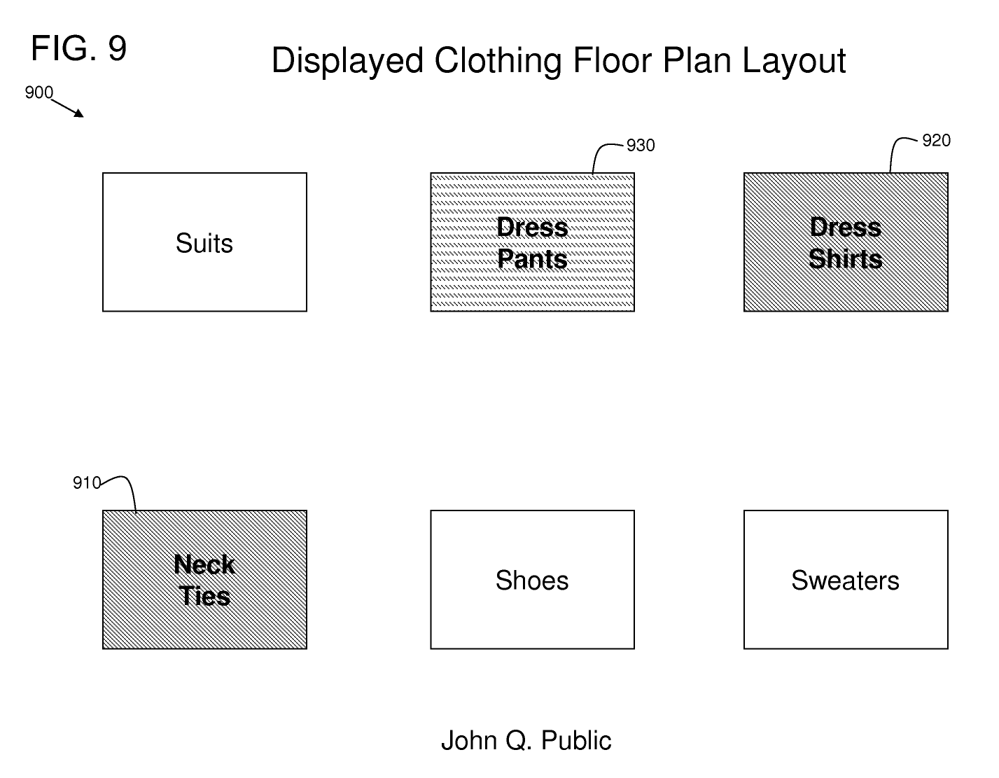

FIG. 9 illustrates a third example embodiment of a tailored customer service 900 derived from the customer activity data 800 of FIG. 8 using the system 100 of FIG. 1. The tailored customer service shown in FIG. 9 is a display of a clothing floor plan layout 900 of at least a portion of the clothing store. The customer service computer 140 of the system 100 uses a customer service software application to operate on the customer activity data 800 to automatically determine and display on the clothing floor plan layout 900 of FIG. 9 the likely types of clothing that John Q. Public is interested in purchasing. The displayed clothing floor plan layout 900 indicates (via shading) that John Q. Public is most interested in neck ties 910 and dress shirts 920, and is somewhat interested in dress pants 930. In this manner, the salesperson 165 can easily view on the display 160 those types of clothing items in which the customer 135 (John Q. Public) is interested.

Upon identification of John Q. Public entering the clothing store by the system 100, the customer service software application of the system 100 operates on the customer activity data 800 to determine which clothing types John Q. Public is likely to want to purchase today. Referring to the prior actual purchases 810 of the customer activity data 800, it is determined by the customer service software application that John Q. Public usually purchases neck ties 910 and dress shirts 920, and sometimes purchases dress pants 930. In this manner, as John Q. Public approaches the point-of-sale location 190 within the clothing store, the salesperson 165 is able to greet the customer 135 by name and immediately view the types of clothing items that the customer 135 is likely interested in on the display 160. Furthermore, certain customer activity data (e.g., notes) may be displayed directing the salesperson 165 to mentally note that the customer 135 prefers conservative blue and gray clothing, and to prepare to steer the customer toward such clothing types within the store. The salesperson 165 can later confirm from the customer (John Q. Public) that he will be paying for any selected purchase items with a credit card.

Furthermore, in accordance with an embodiment of the present invention, once the credit card payment method is confirmed, the system 100 may be directed by the salesperson 165 to automatically make payment to the customer's credit card (assuming the credit card information is already stored in the system 100) for any purchases the customer 135 decides to make. In general, the systems of FIG. 1 and FIG. 2 may be configured to make automatic payment using a credit card account or some other type of payment account associated with the customer via, for example, the internet or dial-up telephone network 170.

In summary, a system and a method for automatically providing tailored customer services at a point-of-sale location are disclosed. An identity of a customer approaching the point-of-sale location is automatically determined using an auto-identifying technology. Stored customer activity data corresponding to the identified customer is automatically accessed using a computer-based system operatively interfacing to the auto-identifying technology. At least one tailored customer service is automatically generated for the identified customer by processing at least a portion of the accessed customer activity data using the computer-based system.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

1. A method for automatically providing tailored customer services at a point-of-sale location, said method comprising:
automatically determining an identity of a customer approaching said point-of-sale location using an auto-identifying technology;
automatically accessing stored customer activity data corresponding to said customer in response to said determined identity using a computer-based system operatively interfacing to said auto-identifying technology; and
automatically generating at least one tailored customer service for said customer by processing at least a portion of said accessed customer activity data through at least one of a likelihood algorithm and a ranking algorithm using said computer-based system.

2. The method of claim 1 wherein said auto-identifying technology includes an identification card and a card-reading technology.

3. The method of claim 1 wherein said auto-identifying technology includes a face-recognition technology.

4. The method of claim 1 wherein said auto-identifying technology includes a biometric identification technology.

5. The method of claim 1 wherein said auto-identifying technology includes radio frequency identification (RFID) technology.

6. The method of claim 1 wherein said computer-based system includes a database storing said customer activity data.

7. The method of claim 1 wherein said computer-based system includes at least one microprocessor for processing at least a portion of said customer activity data.

8. The method of claim 1 wherein said customer activity data includes at least one of prior actual purchase data of said customer, prior actual order data of said customer, preferences of said customer, demographic data of said customer, personal information of said customer, notes entered relating to said customer.

9. The method of claim 1 wherein said generating at least one tailored customer service includes automatically placing an order for said customer.

10. The method of claim 1 wherein said generating at least one tailored customer service includes automatically placing an order for said customer and automatically making payment for said order.

11. The method of claim 1 wherein said generating at least one tailored customer service includes automatically displaying at least one item said customer is likely to order in a computer-selectable format.

12. The method of claim 11 further comprising said customer selecting at least one of said displayed at least one item using said computer-based system.

13. The method of claim 11 further comprising a sales person selecting at least one of said displayed at least one item using said computer-based system in response to said customer verbalizing an order to said sales person.

14. The method of claim 1 wherein said generating at least one tailored customer service includes automatically placing said customer into a queue.

15. The method of claim 1 wherein said generating at least one tailored customer service includes automatically determining where to seat said customer.

16. A system for automatically providing tailored customer services at a point-of-sale location, said system comprising:
a sensor capable of sensing at least one characteristic feature of a customer;
an auto-identifier computer operatively connected to said sensor and capable of automatically determining an identity of said customer approaching said point-of-sale location in response to said at least one characteristic feature of said customer;
a customer activity database storing customer activity data; and
a customer service computer operatively connected to said auto-identifier computer and said customer activity database and capable of automatically accessing said stored customer activity data from said database corresponding to said customer in response to said determined identity, and further capable of automatically generating at least one tailored customer service for said customer by processing at least a portion of said accessed customer activity data through at least one of a likelihood algorithm and a ranking algorithm.

17. The system of claim 16 further comprising a point-of-sale display operatively connected to said customer service computer and capable of displaying at least a portion of said tailored customer service.

18. The system of claim 16 wherein said customer activity data includes at least one of prior actual purchase data of said customer, prior actual order data of said customer, preferences of said customer, demographic data of said customer, personal information of said customer, notes entered relating to said customer.

19. The system of claim 16 wherein said at least one tailored customer service includes automatically placing an order for said customer using said customer service computer.

20. The system of claim 16 wherein said at least one tailored customer service includes automatically placing an order for said customer and automatically making payment for said order using said customer service computer.

21. The system of claim 17 wherein said at least one tailored customer service includes automatically displaying at least one item said customer is likely to order on said display in a computer-selectable format.

22. The system of claim 21 wherein said display includes a touch screen allowing said customer to select at least one of said displayed at least one item.

23. The system of claim 21 wherein said display includes a touch screen allowing a sales person to select at least one of said displayed at least one item in response to said customer verbalizing an order to said sales person.

24. The system of claim 16 wherein said at least one tailored customer service includes automatically placing said customer into a queue using said customer service computer.

25. The system of claim 16 wherein said at least one tailored customer service includes automatically determining where to seat said customer using said customer service computer.

26. A system for automatically providing tailored customer services at a point-of-sale location, said system comprising:
means for automatically determining an identity of a customer approaching said point-of-sale location;
means for automatically accessing stored customer activity data corresponding to said customer in response to said determined identity; and
means for automatically generating at least one tailored customer service for said customer by using at least a portion of said accessed customer activity data, wherein said means for automatically generating includes at least one of a likelihood algorithm and a ranking algorithm.

27. The system of claim 26 wherein said customer activity data includes at least one of prior actual purchase data of said customer, prior actual order data of said customer, preferences of said customer, demographic data of said customer, personal information of said customer, notes entered relating to said customer.

28. The system of claim 26 wherein said means for automatically generating at least one tailored customer service includes means for automatically placing an order for said customer.

29. The system of claim 26 wherein said means for automatically generating at least one tailored customer service includes means for automatically placing an order for said customer and means for automatically making payment for said order.

30. The system of claim 26 wherein said means for automatically generating at least one tailored customer service includes means for automatically displaying at least one item said customer is likely to order in a computer-selectable format.

31. The system of claim 30 further comprising means for said customer to select at least one of said displayed at least one item.

32. The system of claim 30 further comprising means for a sales person to select at least one of said displayed at least one item in response to said customer verbalizing an order to said sales person.

33. The system of claim 26 wherein said means for generating at least one tailored customer service includes means for automatically placing said customer into a queue.

34. The system of claim 26 wherein said means for generating at least one tailored customer service includes means for automatically determining where to seat said customer.
